(19) United States
(12) Patent Application Publication
(10) Pub. No.: US 2013/0062205 A1
(43) Pub. Date: Mar. 14, 2013

(54) ACTIVE MATRIX DEVICE FOR FLUID CONTROL BY ELECTRO-WETTING AND DIELECTROPHORESIS AND METHOD OF DRIVING

(71) Applicants: Benjamin James HADWEN, Oxford (GB); Gareth JOHN, Berkshire (GB); Patrick ZEBEDEE, Oxford (GB)

(72) Inventors: Benjamin James HADWEN, Oxford (GB); Gareth JOHN, Berkshire (GB); Patrick ZEBEDEE, Oxford (GB)

(73) Assignee: SHARP KABUSHIKI KAISHA, Osaka (JP)

(21) Appl. No.: 13/232,298

(22) Filed: Sep. 14, 2011

(51) Int. Cl. G01N 27/26

(52) U.S. Cl. 204/451; 204/601

(57) ABSTRACT

A microfluidic device includes a plurality of array elements configured to manipulate one or more droplets of fluid on an array, each of the array elements including a top substrate electrode and a drive electrode between which the one or more droplets may be positioned, the top substrate electrode being formed on a top substrate, and the drive electrode being formed on a lower substrate; and active matrix drive circuitry arranged to provide drive signals to the top substrate and drive electrodes of the plurality of array elements to manipulate the one or more droplets among the plurality of array elements. With respect to one or more of the array elements the active matrix drive circuitry is configured to provide the drive signals to the top substrate and drive electrodes to selectively manipulate the one or more droplets within the array element both by Electro-wetting-on-Dielectric (EWOD) and by Dielectrophoresis (DEP).

### TECHNICAL FIELD

The present invention relates to active matrix arrays and elements thereof. In a particular aspect, the present invention relates to digital microfluidics, and more specifically to Active Matrix Electro-wetting-On-Dielectric (AM-EWOD). Electro-wetting-On-Dielectric (EWOD) is a known technique for manipulating droplets of fluid on an array. Active Matrix EWOD (AM-EWOD) refers to implementation of EWOD in an active matrix array, for example by using thin film transistors (TFTs). The invention further relates to methods of driving such a device.

### BACKGROUND ART

Electro-wetting on dielectric (EWOD) is a well known technique for manipulating droplets of fluid by application of an electric field. It is thus a candidate technology for digital microfluidics for lab-on-a-chip technology. An introduction to the basic principles of the technology can be found in “Digital microfluidics: is a true lab-on-a-chip possible?”, R. B. Fair, Microfluid Nanofluid (2007) 3:245-281).

U.S. Pat. No. 6,565,727 (Shenderov, issued May 20, 2003) discloses a passive matrix EWOD device for moving droplets through an array.

U.S. Pat. No. 6,911,132 (Pamula et al, issued Jun. 28, 2005) discloses a two dimensional EWOD array to control the position and movement of droplets in two dimensions.

U.S. Pat. No. 6,565,727 further discloses methods for other droplet operations including the splitting and merging of droplets and the mixing together of droplets of different materials. In general the voltages required to perform typical droplet operations are relatively high. Values in the range 20V-60V are quoted in the prior art (e.g. U.S. Pat. No. 7,329,545 (Pamula et al., issued Feb. 12, 2008)). The value required depends principally on the technology used to create the insulator and hydrophobic layers.

A notable feature of the EWOD actuation mechanism is that the contact angle of the liquid droplet with the solid surface depends on the square of the actuation voltage; the sign of the applied voltage is unimportant to first order. It is thus possible to implement EWOD with either an AC or a DC drive scheme.

There are several advantages of implementing EWOD with an AC drive scheme. These advantages include:
Reduced device degradation through life
Improved insulator reliability
Improved droplet dynamics
   For these reasons most groups working on EWOD use AC drive schemes with drive frequencies of typically 10 kHz or higher.

Many modern liquid crystal (LC) displays use an Active Matrix (AM) arrangement whereby thin-film transistors control the voltage maintained across the liquid crystal layer.

LC displays generally require that the voltage across the liquid crystal should be alternated (“inversion”) since the application of a DC field has deleterious effects for the LC material. Most LC inversion schemes operate so as to invert the sign of the applied LC voltage with each frame of information written to the display. This is typically a frequency of 50-60 Hz.

“Ultra-Low Power System-LCD with Pixel Memory Circuit”, Matsuda et al., Proceedings of IDW '09, AMD1-2, describes an LCD with a pixel memory driving scheme. Pixel memory refers to a technology whereby the data written to the display is held by an SRAM memory cell within the pixel. The display is thus 1-bit, i.e. it can only display black or white and not intermediate grey levels. The advantage of such an implementation is that it removes the requirement to periodically refresh the voltage written to the display and thus reduces power consumption. In order to effect inversion of the voltage across the LC layer, an additional inversion circuit is also included in pixel. This enables the inversion frequency to be higher than the data refresh rate of the display.

U.S. Pat. No. 7,163,612 (J. Sterling et al.; issued Jan. 16, 2007) describes how TFT based electronics may be used to control the addressing of voltage pulses to an EWOD array by using circuit arrangements very similar to those employed in AM display technologies.

Such an approach may be termed “Active Matrix Electro-wetting on Dielectric” (AM-EWOD). There are several advantages in using TFT based electronics to control an EWOD array, namely:
Driver circuits can be integrated onto the AM-EWOD array substrate.
TFT-based electronics are well suited to the AM-EWOD application. They are cheap to produce so that relatively large substrate areas can be produced at relatively low cost
TFTs fabricated in standard processes can be designed to operate at much higher voltages than transistors fabricated in standard CMOS processes. This is significant since many EWOD technologies may require EWOD actuation voltages in excess of 20V to be applied.

An alternative technology for implementing droplet microfluidics is Dielectrophoresis (DEP). Dielectrophoresis is a phenomenon whereby a force may be exerted on a dielectric particle by subjecting it to a varying electric field.

Unlike EWOD (which is a contact line phenomenon associated with the properties of surfaces), DEP is a bulk phenomenon associated with the different polarisabilities of a dielectric particle and its surrounding medium. “Integrated circuit/microfluidic chip to programmably trap and move cells and droplets with dielectrophoresis”, Thomas P Hunt et al, Lab Chip, 2008, 8,81-87 describes a silicon integrated circuit (IC) backplane to drive a dielectrophoresis array for digital microfluidics. This reference describes an integrated circuit for driving AC waveforms to array elements, shown in FIG. 1. The circuit consists of a standard SRAM memory cell 104 to which data can be written and stored, switch circuitry 106, and an output buffer stage 108. According to the operation of the switches 110 and 112 either the AC signal Vpix (shown as a 5V 1 MHz square wave in this example) or complementary signal V̅p̅i̅x̅ is written to the pixel. This reference also gives an overview of the physics of DEP, and describes how the DEP force depends on the gradient of the electric field squared, the complex permittivities of the particle and dielectric medium and geometrical factors.

Lab Chip, 2008, 8, 1325-1331 (Fan et al, 28 May 2008) describes how both EWOD and DEP can be implemented in a passive EWOD device to control both a liquid droplet and also the movement of particles within a droplet. The basic arrangement of the electrodes in this device is shown in FIG. 2. The large, square electrodes 48 are used to manipulate the position of the liquid droplets using the EWOD actuation mechanism as is well know. The smaller rectangular electrodes 50 may then be used for manipulating dielectric particles within the droplet using the DEP actuation measurement, for example to sort dielectric particles to one side of the droplet.

A notable disadvantage of such passive architectures for implementing EWOD and/or DEP is that a separate electrical connecting wire (e.g. 52) must be made to each individual electrode. The total number of individually controllable elements within an array is thus limited by the number of electrical inputs to the device. This makes large arrays impractical to implement.

### SUMMARY OF INVENTION

This invention describes active matrix architectures for manipulating fluidic droplets by both EWOD and DEP mechanisms. Active matrix array elements may be realized where liquid droplets can be manipulated by either EWOD or DEP.

According to an aspect of the invention, active matrix drive circuitry is arranged such that the actuation mechanism (EWOD or DEP) can be selected individually for each column in the array at any particular time.

According to a further aspect of the invention, a method of driving is disclosed whereby the drive signals applied across a liquid droplet can be selected to be either a DC or low frequency AC voltage waveform for actuating the droplet by EWOD, or else a high frequency AC voltage waveform for actuating the droplet by DEP.

According to an aspect of the invention, a microfluidic device is provided which includes a plurality of array elements configured to manipulate one or more droplets of fluid on an array, each of the array elements including a top substrate electrode and a drive electrode between which the one or more droplets may be positioned, the top substrate electrode being formed on a top substrate, and the drive electrode being formed on a lower substrate; and active matrix drive circuitry arranged to provide drive signals to the top substrate and drive electrodes of the plurality of array elements to manipulate the one or more droplets among the plurality of array elements. With respect to one or more of the array elements the active matrix drive circuitry is configured to provide the drive signals to the top substrate and drive electrodes to selectively manipulate the one or more droplets within the array element both by Electro-wetting-on-Dielectric (EWOD) and by Dielectrophoresis (DEP).

In accordance with another aspect, the active matrix drive circuitry is operative to render the device reconfigurable in that the one or more droplets in a given part of the array can be manipulated by EWOD at one time and by DEP at another time.

In accordance with still another aspect, the active matrix drive circuitry is configured to selectively provide the drive signals the top substrate and drive electrodes of the one or more array elements in order to be either a DC or relatively low frequency AC voltage waveform across the one or more liquid droplets to manipulate the one or more liquid droplets by EWOD, or a relatively high frequency AC voltage waveform for manipulating the one or more droplets by DEP.

According to yet another aspect, the one or more array elements are located in different parts of the array, and the active matrix drive circuitry is configured so as to be capable of manipulating at the same time some of the one or more droplets in one of the parts by EWOD and others of the one or more droplets in another of the parts by DEP.

In yet another aspect, the array elements are arranged in an M×N array, where M and N are both equal to or greater than 2.

According to another aspect, the active matrix drive circuitry is configured in order that EWOD or DEP actuation may be selected individually for each column in the array at any particular time.

In accordance with another aspect, the active matrix circuitry includes a row driver circuit configured to select rows within the array, a first column driver circuit for providing write voltages to the array elements within a given row when selected, and a second column driver circuit for providing the drive signals to the top substrate electrodes and drive electrodes of respective columns within the array to selectively manipulate the one or more droplets within the respective columns by EWOD or DEP based on the write voltages provided to the array elements within the respective columns.

According to another aspect, the active matrix circuitry is configured with respect to some columns in the array to manipulate the one or more droplets solely using EWOD, and with respect to other columns in the array to manipulate the one or more droplets selectively by EWOD or DEP.

In still another aspect, the active matrix drive circuitry is configured in order that EWOD or DEP actuation is selected individually for each row in the array at any particular time.

According to another aspect, the drive signals include at least one of DC signal and a relatively low frequency signal, a relatively high frequency signal, and logical complements thereof.

With still another aspect, the DC signal and its logical complement are selectively applied to the top substrate electrode and the drive electrode of a given array element to manipulate the one or more droplets therein by DC EWOD.

In accordance with another aspect, the relatively low frequency signal and its logical complement are selectively applied to the top substrate electrode and the drive electrode of a given array element to manipulate the one or more droplets therein by AC EWOD.

According to still another aspect, the relatively high frequency signal and its logical complement are selectively applied to the top substrate electrode and the drive electrode of a given array element to manipulate the one or more droplets therein by DEP.

In accordance with another aspect, the array elements have a large aspect ratio.

According to still another aspect, the array elements share a common top substrate electrode.

According to yet another aspect of the invention, a method of driving a microfluidic device which includes a plurality of array elements configured to manipulate one or more droplets of fluid on an array is provided. The method includes selectively supplying by way of active matrix drive circuitry a DC or relatively low frequency AC voltage, and a relatively high frequency AC voltage, across the one or more droplets within one or more of the array elements to manipulate the one or more droplets by Electro-wetting-on-Dielectric (EWOD) and Dielectrophoresis (DEP), respectively.

In accordance with another aspect, the method includes manipulating the one or more droplets in a given part of the array by EWOD at one time and by DEP at another time.

According to another aspect, the method includes manipulating at the same time some of the one or more droplets in one part of the array by EWOD and others of the one or more droplets in another part by DEP.

In accordance with still another aspect, the array elements are arranged in an M×N array, where M and N are both equal to or greater than 2, and the active matrix drive circuitry is configured in order that EWOD or DEP actuation may be selected individually for each column in the array at any particular time.

According to yet another aspect, the active matrix circuitry includes a row driver circuit configured to select rows within the array, a first column driver circuit for providing write voltages to the array elements within a given row when selected, and a second column driver circuit for providing the drive signals to the respective columns within the array to selectively manipulate the one or more droplets within the respective columns by EWOD or DEP based on the write voltages provided to the array elements within the respective columns.

Advantages of the invention include that large format, reconfigurable AM-EWOD devices can be realized with additional DEP functionality. The addition of DEP as a second actuation mechanism enables dielectric particles (e.g. cells, beads) within a liquid droplet to be manipulated separately to the body of the liquid droplet. This may be used for applications such as sample washing and cell concentration.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1 shows prior art: the array element circuit of a backplane for control of droplets by dielectrophoresis;

FIG. 2 shows prior art: a passive device architecture for implementing EWOD and DEP;

FIG. 3 shows an AM-EWOD device in schematic perspective in accordance with an exemplary embodiment of the invention;

FIG. 4 shows a cross section through some of the array elements of the device;

FIG. 5 shows a schematic illustration of the arrangement of thin film electronics in the device;

FIG. 6 shows a schematic illustration of the array element circuit of a first embodiment;

FIG. 7 shows a schematic illustration of the second column driver circuit of a first embodiment;

FIG. 8 shows exemplary timing signals of the drive signals V1A, V1B and V1C in accordance with a first embodiment;

FIG. 9 shows a circuit model representing the electrical characteristics of the insulator layer, hydrophobic layer and liquid droplet;

FIGS. 10A-10C shows the operation of the device of the first embodiment to perform the operation of particle concentration by DEP;

FIG. 11 shows a schematic illustration of the arrangement of thin film electronics in the device according to a second embodiment of the invention;

FIG. 12 shows a schematic illustration of the array element circuit according to a third embodiment of the invention; and

FIG. 13 shows a schematic illustration of the arrangement of thin film electronics in the device according a fourth embodiment of the invention.

### DESCRIPTION OF REFERENCE NUMERALS

4 liquid droplet

6 contact angle θ

16 Hydrophobic surface

20 Insulator layer

26 Hydrophobic layer

28 Electrode

32 Spacer

34 Non-ionic liquid

36 Top substrate

38 Electrode

40 Circuit node

42 Electrode array

43 Array element

44 Particle

46 DEP zone

48 Electrode

50 Electrode

52 Wire

72 Lower substrate

74 Thin film electronics

76 Row driver circuit

78 First column driver circuit

80 Serial interface

82 Connecting wires

83 Voltage supply interface

84 Array element circuit

86 Second column driver circuit

104 SRAM memory cell

106 Switch circuitry

108 Output buffer stage

110 Switch transistor

112 Switch transistor

203 Storage capacitor

206 Switch transistor

210 Memory node

212 Inverter

214 First analogue switch

216 Second analogue switch

222 Memory circuit

224 Inversion circuit

226 First inverter

228 Second inverter

230 Switch transistor

240 Analogue switch

242 Analogue switch

500 Element of second column driver circuit

502 First bank of three switches

504 Second bank of three switches

506 Digital output select circuit

508 Digital control circuit

### DETAILED DESCRIPTION OF INVENTION

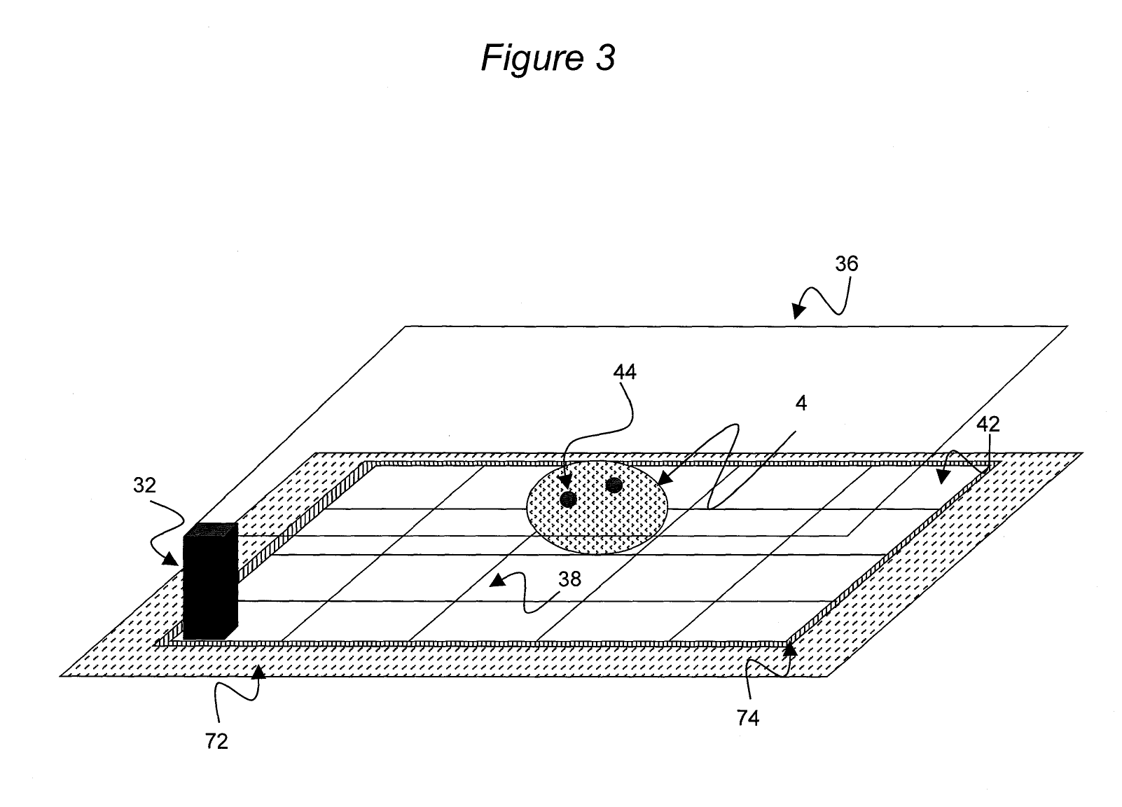

Referring to FIG. 3, shown is a droplet microfluidic device in accordance with an exemplary embodiment of the present invention. The droplet microfluidic device is an active matrix device with the capability of manipulating fluids by both EWOD and by DEP. The device is further capable of manipulating droplets by EWOD in one part of the array and at the same time manipulating droplets by DEP in another part of the array. The device is also reconfigurable such that a droplet in a given part of the array can be manipulated by EWOD at one time and by DEP at another time.

The droplet microfluidic device has a lower substrate 72 with thin film electronics 74 disposed upon the substrate 72. The thin film electronics 74 are arranged to drive array element electrodes, e.g. 38. A plurality of array element electrodes 38 are arranged in an electrode array 42, having M×N elements where M and N may be any number. In the exemplary embodiments herein, M and N are both equal to or greater than 2. A liquid droplet 4 is enclosed between the substrate 72 and the top substrate 36, although it will be appreciated that multiple droplets 4 can be present without departing from the scope of the invention. The liquid droplet 4 may also contain one or more particles 44 suspended within it. The particles 44 may have electrical properties that are different to the liquid droplet and/or to other particles contained within the liquid droplet 4.

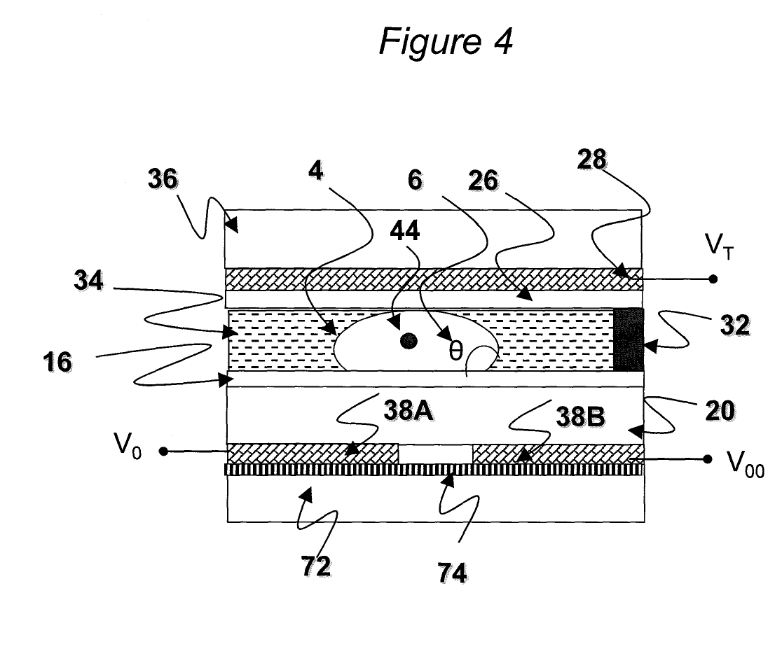

FIG. 4 shows a pair of the array elements in cross section. The device includes the lower substrate 72 having the thin-film electronics 74 disposed thereon. The uppermost layer of the lower substrate 72 (which may be considered a part of the thin film electronics layer 74) is patterned so that a plurality of electrodes 38 (e.g., 38A and 38B in FIG. 4) are realised. These may be termed the EW drive elements. The term EW drive element may be taken in what follows to refer both to the electrode 38 associated with a particular array element, and also to the node of an electrical circuit directly connected to this electrode 38. The droplet 4, consisting of an ionic material is constrained in a plane between the lower substrate 72 and the top substrate 36. A suitable gap between the two substrates may be realised by means of a spacer 32, and a non-ionic liquid 34 (e.g. oil) may be used to occupy the volume not occupied by the droplet 4. An insulator layer 20 disposed upon the lower substrate 72 separates the conductive electrodes 38A, 38B from the hydrophobic surface 16 upon which the droplet 4 sits with a contact angle 6 represented by θ. On the top substrate 36 is another hydrophobic layer 26 with which the droplet 4 may come into contact. Interposed between the top substrate 36 and the hydrophobic layer 26 is a top substrate electrode 28. The top substrate electrode 28 in the exemplary embodiment is common to all of the array elements, although it will be appreciated that each array element or groups of array elements may have its own top substrate electrode.

By appropriate design and operation of the thin film electronics 74, different voltages, termed the EW drive voltages, (e.g. V_{T}, V₀ and V₀₀) may be applied to different electrodes (e.g. drive element electrodes 28, 38A and 38B, respectively). The hydrophobicity of the hydrophobic surface 16 can be thus be controlled, thus facilitating droplet movement in the lateral plane between the two substrates 72 and 36.

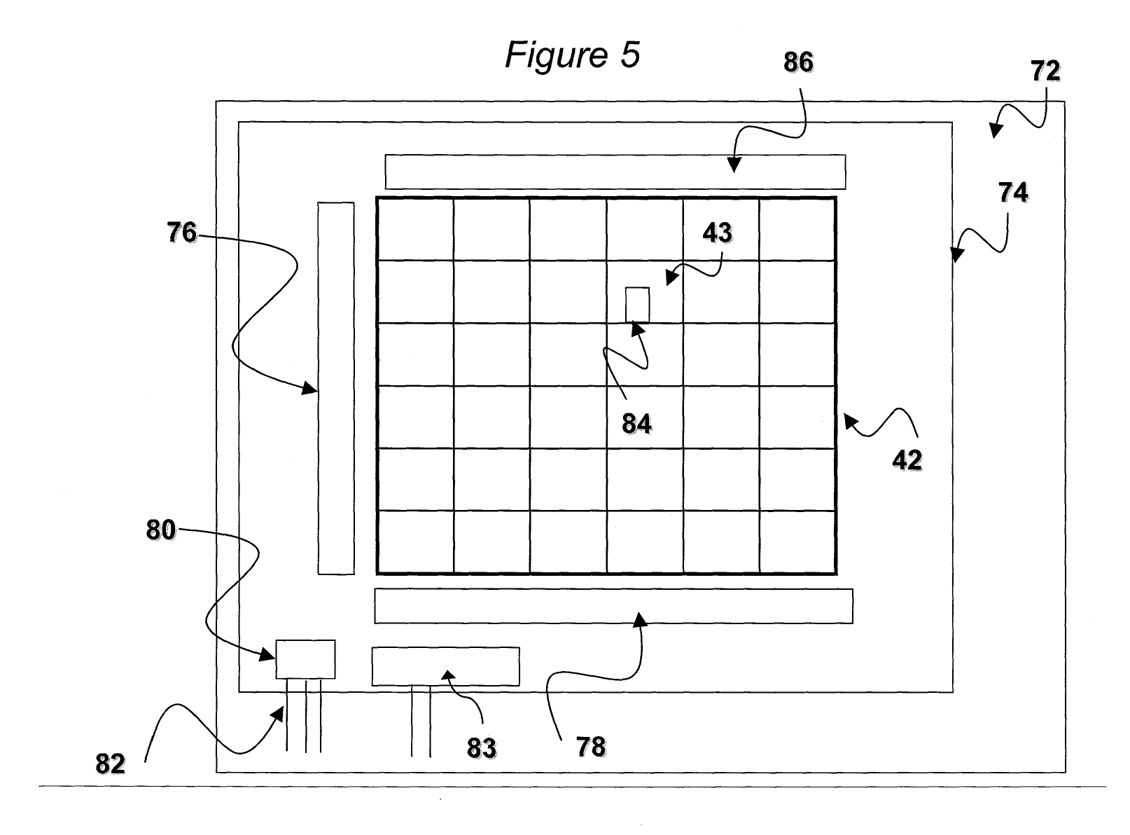

The arrangement of thin film electronics 74 upon the substrate 72 is shown in FIG. 5. Each array element 43 of the electrode array 42 contains an array element circuit 84 for controlling the electrode potential of a corresponding electrode 38. Integrated row driver 76 and first column driver circuit 78 circuits are also implemented in thin film electronics to supply control signals to the array element circuits 84. A second column driver circuit 86 is also implemented to supply control signals to the array element circuits 84. In the exemplary embodiments, the row driver 76, first column driver 78, second column driver circuit 86 and array element circuits 84 make up active matrix drive circuitry for providing drive signals to the top substrate electrode 28 and drive element electrode 38 of each array element 43.

A serial interface 80 may also be provided to process a serial input data stream and write the required voltages to the electrode array 42. A voltage supply interface 83 provides the corresponding supply voltages, top substrate drive voltages, etc., as described herein. The number of connecting wires 82 between the array substrate 72 and external drive electronics, power supplies etc. can be made relatively few, even for large array sizes.

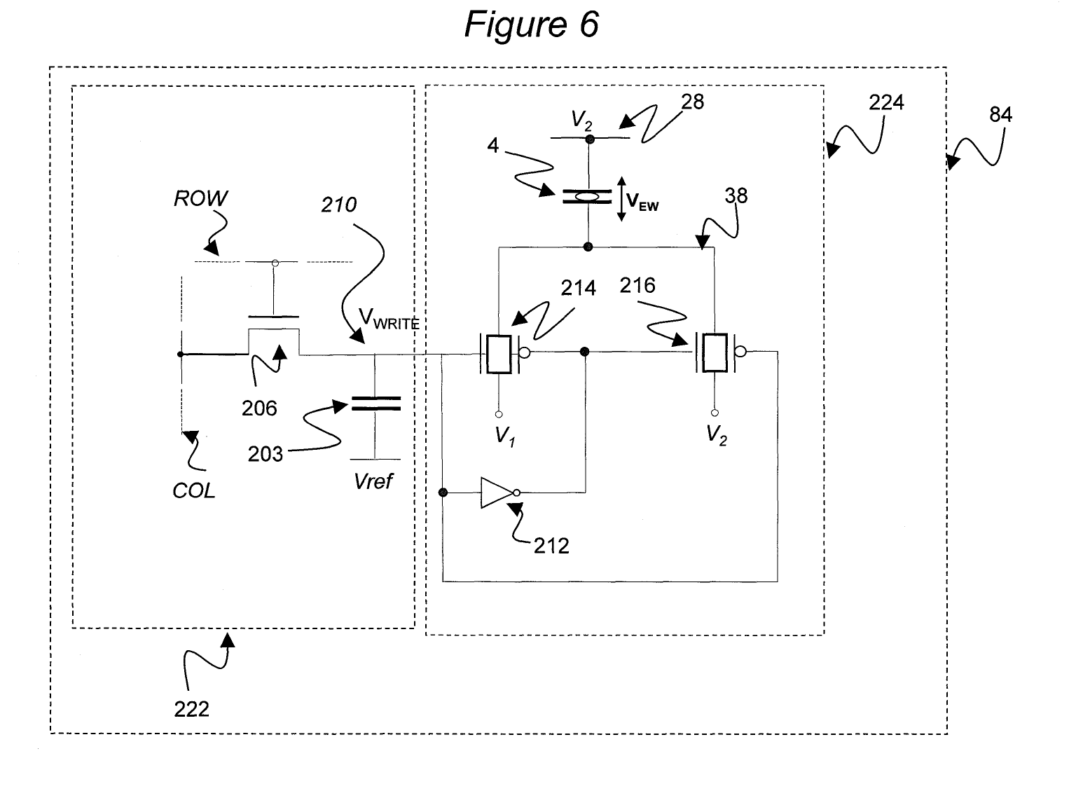

The array element circuit 84 according to a first embodiment is shown in FIG. 6. The remainder of the AM-EWOD device is of the standard construction previously described.

Each array element circuit 84 is arranged so as to supply a drive voltage V_{EW} across the liquid droplet 4 and includes the following components:
A memory circuit 222 including:
   A column write line COL (originating from the first column driver circuit 78), which may be common to array elements within the same column
   A row select line ROW (originating from the row driver circuit 76), which may be common to array elements within the same row
   A storage capacitor 203
   A DC supply voltage Vref
   A switch transistor 206
An inversion circuit 224 including:
   A first analogue switch 214
   A second analogue switch 216
   A supply voltage V₁ (originating from the second column driver circuit 86) which may be common to array elements within the same column
   A second supply voltage V₂ (originating from the second column driver circuit 86) which may be common to all elements within the same column
   An inverter 212

The array element circuit 84 is connected as follows:

The column write line COL is connected to the source of the switch transistor 206. The row select line ROW is connected to the gate of the switch transistor 206. The storage capacitor 203 is connected between the DC supply voltage Vref and the drain of the switch transistor 206. The drain of the switch transistor 206 is connected to the input of the inverter 212, the gate of the n-type transistor of the first analogue switch 214 and the gate of the p-type transistor of the second analogue switch 216. The output of the inverter 212 is connected to the gate of the p-type transistor of the first analogue switch 214 and to the gate of the n-type transistor of the second analogue switch 216. The supply voltage V₁ is connected to the input of the first analogue switch 214. The supply voltage V₂ is connected to the input of the second analogue switch 216 and to the top substrate electrode 28. The outputs of the first analogue switch 214 and the second analogue switch 216 are each connected to the electrode 38 forming the EW drive electrode.

The array element circuit 84 operates so as to supply a voltage signal, either V₁ or V₂, to the EW drive electrodes 38 of each array element.

The operation of the array element circuit 84 is described as follows:

The array element circuit 84 includes the aforementioned two functional blocks, the memory circuit 222 and the inversion circuit 224. The memory circuit 222 is a standard DRAM circuit. A digital write voltage V_{WRITE} corresponding to either logic “0” or logic “1” state may be written to the memory by loading the column write line COL with the required voltage and then applying a high level voltage pulse to the row select line ROW. This turns on the switch transistor 206 and the write voltage is then written to the memory node 210 and stored across the storage capacitor 203. Due to leakage of the switch transistor 206, the memory circuit 222 must be re-written to periodically so as to refresh the V_{WRITE} voltage at the memory node 210.
In the case where logic “1” state is written to the memory circuit 222, the inversion circuit 224 becomes configured such that the first analogue switch 214 is turned on, and the second analogue switch 216 is turned off. As a result supply voltage V₁ is applied to the electrode forming the EW drive element 38. In the case where logic “0” state is written to the memory function 222, the inversion circuit 224 becomes configured such that the first analogue switch 214 is turned off, and the second analogue switch 216 is turned on. In this case supply voltage V₂ is applied to the conductive electrode forming the EW drive electrode 38.

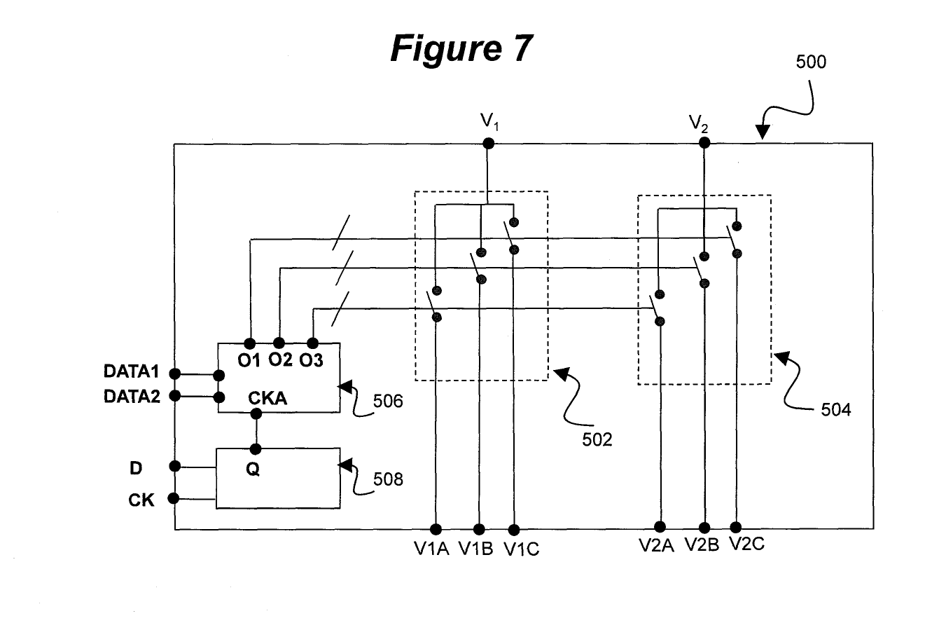

The supply voltages V₁ and V₂ may be common to array elements within the same column and are supplied by the second column driver circuit 86, and hence are also referred to herein as column lines V₁ and V₂. A possible circuit arrangement for the second column driver circuit 86 is as follows. The second column driver circuit 86 may include a number of circuit elements 500, with one element 500 for each column of the array. FIG. 7 shows an exemplary arrangement of the circuitry of an element 500 of the second column driver circuit 86. Each circuit element 500 includes:
A first bank of three switches 502
A second bank of three switches 504
A digital output select circuit 506
A digital control circuit 508

The digital control circuit 508 has an external clock input CK and an output Q which connects to a clock input CKA of the digital output select circuit 506. The digital output select circuit 506 has a two bit data input DATA1 and DATA2 and a three bit parallel data output O1 and O2 and O3. The three outputs O1, O2 and O3 of the digital output select circuit 506 are used to control the three switches in the banks of switches 502 and 504. The outputs of the three switches in bank 502 are connected together and are connected to the output V₁ representing the supply voltage which is provided to the first analogue switch 214 in the respective array elements. The outputs of the three switches in bank 504 are connected together and are connected to the output V₂ representing the supply voltage which is provided to the second analogue switch 216 in the respective array elements and to the top substrate electrode 28. The inputs V1A, V1B and V1C comprise the three inputs to the bank of three switches 502, and the inputs V2A, V2B and V2C comprise the three inputs to the bank of three switches 504. These inputs may be global signals externally supplied to the device.

The operation of second column driver circuit element 500 is described as follows. The second column driver circuit element 500 essentially functions so as to switch one of the three input signals V1A, V1B or V1C to the output V₁ which is then input to the array elements within that particular column of the array. Similarly, V2A, V2B or V2C is switched to the output V₂, such that when V₁=V1A then also V₂=V2A and when V₁=V1B then also V₂=V2B, and when V₁=V1C then also V₂=V2C.

The choice of input signal switched to V₁ is determined by the digital word on inputs DATA1 and DATA2, for example DATA1=0, DATA2=0 may be configured to switch V1A to V₁, DATA1=0, DATA2=1 may be configured to switch V1B to V₁ and DATA1=1, DATA2=0 may be configured to switch V1C to V₁. The digital output select circuit 506 may be implemented with standard logic elements (e.g. inverters and NAND gates) using standard means as is very well known. The digital control circuit 508 may be implemented as a shift register element, for example using flip-flops and latches such that the logic level of input D is sampled to the output Q on the rising edge of clock input CK. The output Q in turn is input to the clock input CKA of the digital output select circuit 506 so that the logic levels of DATA1 and DATA2 are sampled to the outputs O1, O2 and O3. The values of DATA1, DATA2, D and CK are provided to the second column driver circuit elements 500 from an external source via the serial interface 80, for example, to carry out EWOD or DEP manipulation in the corresponding array elements as desired.

The second column driver element circuit 500 thus operates to determine the signal switched to the column line V1 for each column of the array, i.e. whether V1A, V1B or V1C. Likewise it also determines the signal switched to the column line V2 for each column of the array, i.e. whether V2A, V2B or V2C.

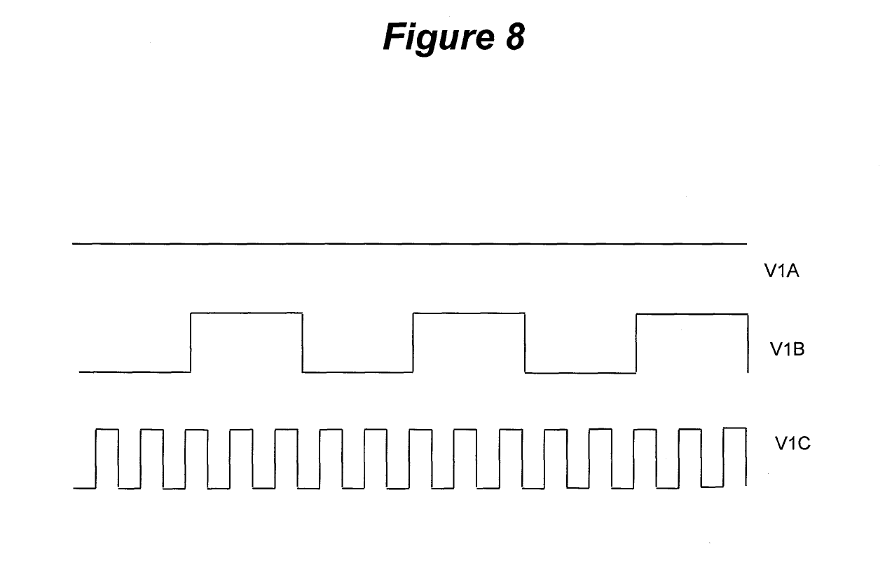

FIG. 8 shows the time dependence of the waveforms of supply voltages V1A, V1B and V1C. V1A is a DC signal at logic high level. V1B is a square-wave of relatively low frequency f₁ of typically 10 kHz. V1C is a square-wave of relatively high frequency f₂ of typically 1 MHz. V2A, V2B and V2C (not shown) are the logical complement of these signals. V1A, V1B and V1C may be global signals, generated and supplied for example by an external PCB. It may be noted that the frequencies f₁ and f₂ may therefore be externally controllable and may be determined and set according to the requirements of operation as will shortly be described.

The overall function of the thin film electronics 74 is thus summarized as follows. Each array element circuit 84 contains a programmable 1-bit memory function which may be programmed by row driver circuit 76 and column driver circuit circuit 78 and which determines whether signal V₁ or V₂ is written to the EW drive electrode 38. The second column driver circuit 86 is used to determine which one of three global input signals V1A, V1B and V1C are written to the V₁ signal of a given column in the array, and likewise which of V2A, V2B and V2C to the V₂ signal of a given column in the array.

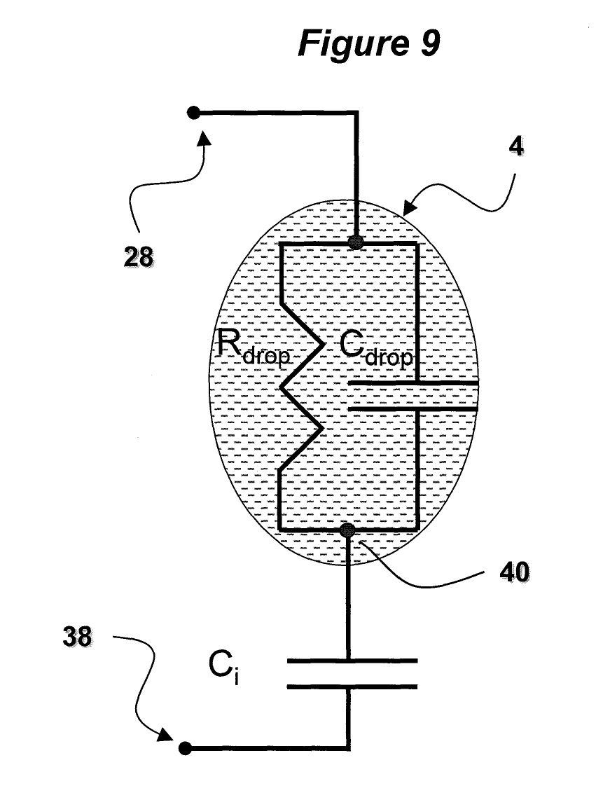

The signals V1A, V1B and V1C are arranged to actuate the droplet 4 by DC electro-wetting, AC electro-wetting and DEP respectively. These functions may be explained with reference to FIG. 9, which shows a circuit model representing the electrical characteristics of the insulator layer 20, hydrophobic layer 16 and liquid droplet 4, between the drive electrode 38 and the top electrode 28 and when a liquid droplet 4 is present at that particular location within the array. For simplicity of description the effect of any particles suspended within the liquid droplet 4 are not here considered. The liquid droplet 4 may be represented as capacitor C_{DROP} in parallel with a resistor R_{DROP}. The circuit node labeled 40 corresponds to the interface between the droplet 4 and the hydrophobic surface 16. The combination of the insulator layer 20 and the hydrophobic layer 16 may be represented electrically as a capacitor Ci. DC electro-wetting, AC electro-wetting and DEP are performed as follows:
To perform DC electro-wetting, the voltage supply V2A is connected to the top substrate electrode 28. The array element circuit 84 at a given location may be programmed so that either V1A or V2A is connected to the drive electrode 38. If the V1A is written to the drive electrode 38, a potential difference equal to the DC potential V1A-V2A is maintained between the electrode 38 and the electrode 28. With reference to FIG. 9, this DC potential is dropped wholly across capacitor Ci resulting in an electric field at the interface between the liquid droplet 4 and the hydrophobic layer 16. This therefore acts to change the contact angle by the mechanism of electro-wetting as is well known and described in prior art references. On the other hand if V2A is written to the drive electrode, the potential difference between the electrode 38 and the electrode 28 is zero and there is no electric field at the interface between the liquid droplet 4 and the hydrophobic layer 16. By suitable choice of signals supplied to different array elements, the positions of liquid droplets 4 in the array may thus be manipulated as is also well known and described in the prior art.
To perform AC electro-wetting, the voltage supply V2B is connected to the top substrate electrode 28. The array element circuit 84 at a given array element may be programmed so that either V1B or V2B is connected to the drive electrode 38. If the V1B is written to the drive electrode, a potential difference equal to the DC potential V1B-V2B is maintained between the electrode 38 and the electrode 28. This corresponds to an AC potential of frequency f₁. The appropriate choice of frequency f₁ for controlling the liquid droplet 4 by AC electro-wetting may be explained with reference to FIG. 9. The electro-wetting force depends on the electric field at the interface between the hydrophobic layer 16 and the liquid droplet 4, and so the general requirement is that most of the applied voltage must be dropped across capacitor Ci and not through the droplet 4 itself. The choice of frequency may depend on the resistance R_{DROP} but is typically quite low, for example 10 kHz. In this low frequency case therefore, an AC electric field is present at the interface between the hydrophobic layer 16 and the liquid droplet 4 (node 40 in FIG. 9) such that the droplet is manipulated by AC electro-wetting as is well known. In the other case whereby the array element circuit 84 is programmed so that V2A is written to the drive electrode, the potential difference between the electrode 38 and the electrode 28 is zero and no electro-wetting force results. Again, by suitable choice of signals supplied to different array elements, the positions of liquid droplets in the array may thus be manipulated by electro-wetting as is also well known and has been described in the prior art.
To perform DEP, the voltage supply V2A is connected to the top substrate electrode 28. The array element circuit 84 at a given location may be programmed so that either V1C or V2C is connected to the drive electrode 38. In both cases the result is that a time varying electric field is applied between electrode 38 and electrode 28. In order to implement DEP, the frequency f₂ of the voltage pulses V1C and V2C must be sufficiently large such that most of the voltage difference between the electrode 38 and the electrode 28 is dropped across the liquid droplet 4. The net result is a time varying electric field in the body of the liquid droplet 4 which may be used to manipulate dielectric particles 44 (which, for example, could be beads or cells) contained within the liquid droplet 4. The exact choice of the frequency f₂ is a function of the real and imaginary components of the permittivities of the liquid droplet medium and of the particles within the droplet being manipulated. This frequency dependency is described by the Claussius-Mossotti factor which is described in prior art references to the DEP phenomenon and which is very well known. Essentially f₂ may be chosen so that either the particles are more polarisable than the dielectric medium of the liquid droplet 4 (positive DEP) or such that the particles 44 are much less polarisable than the dielectric medium of the liquid droplet (negative DEP). The choice of frequency and whether to use positive or negative DEP depend to a large extent on the dielectric properties of the liquid droplet 4 and the particles 44 being manipulated. By suitable choice of signals supplied to different array elements, DEP may be used to manipulate the positions of particles within a liquid droplet. In an alternative implementation, DEP may be performed with signal V2B supplied to the top electrode. The operation would be essentially the same, except that the polarity of the V1C and V2C signals would need to be inverted at the times when V2B was at logic high level. This would be in order to ensure that the magnitude of the electric field in the device is the same when V2B is at the high level as when it is at the low level.

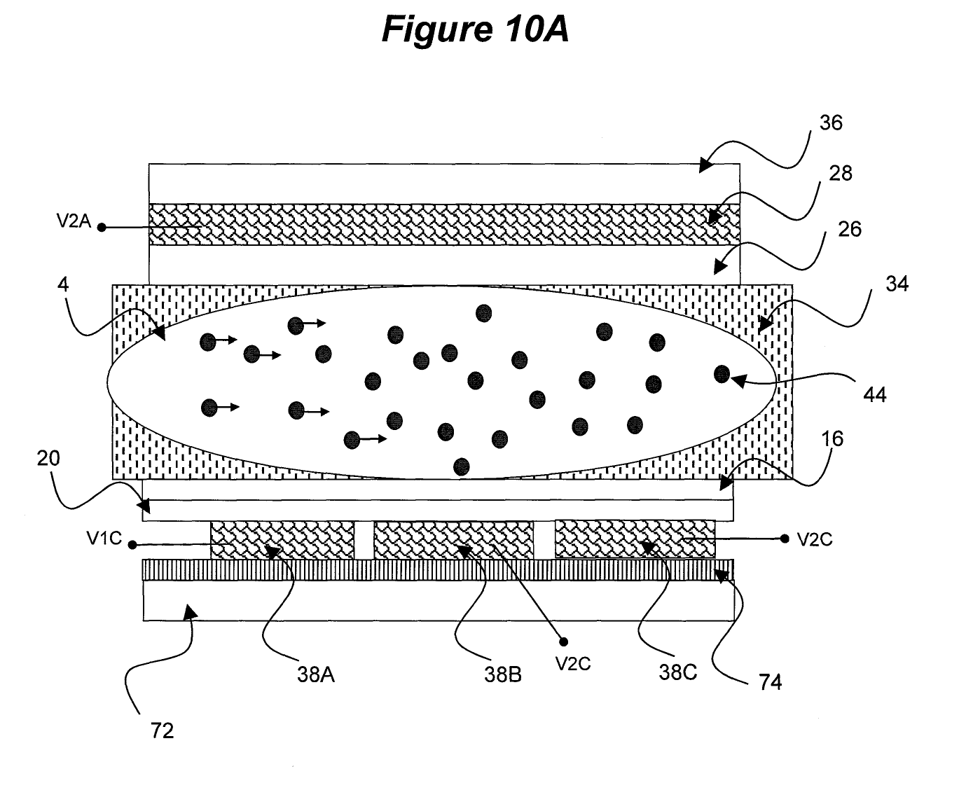

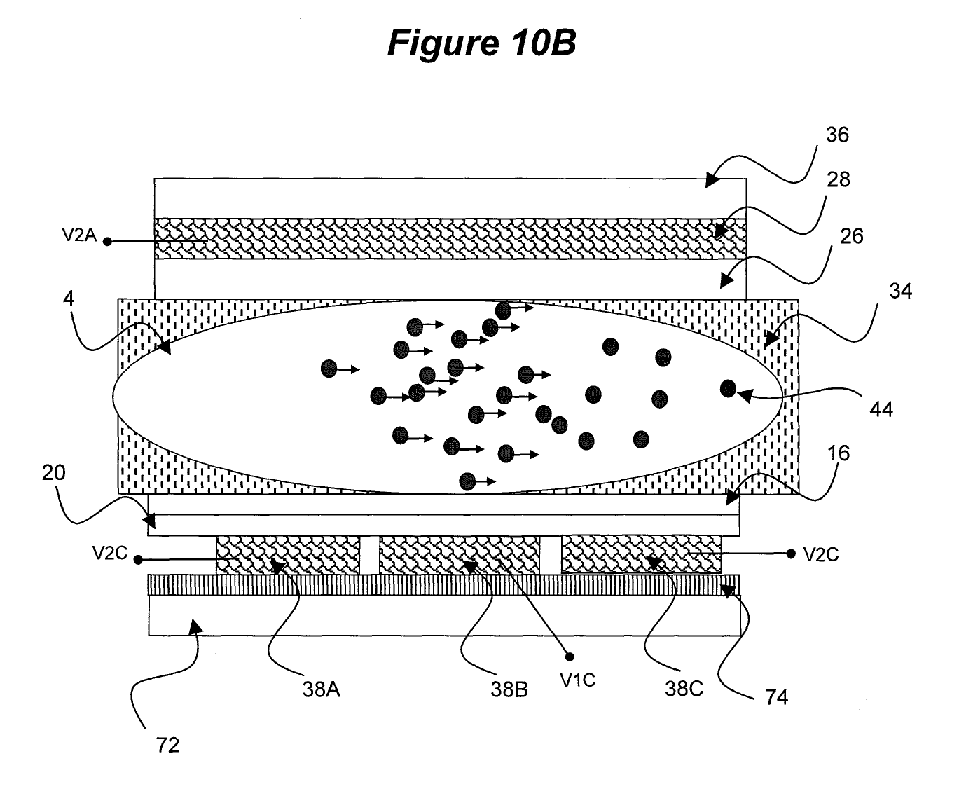

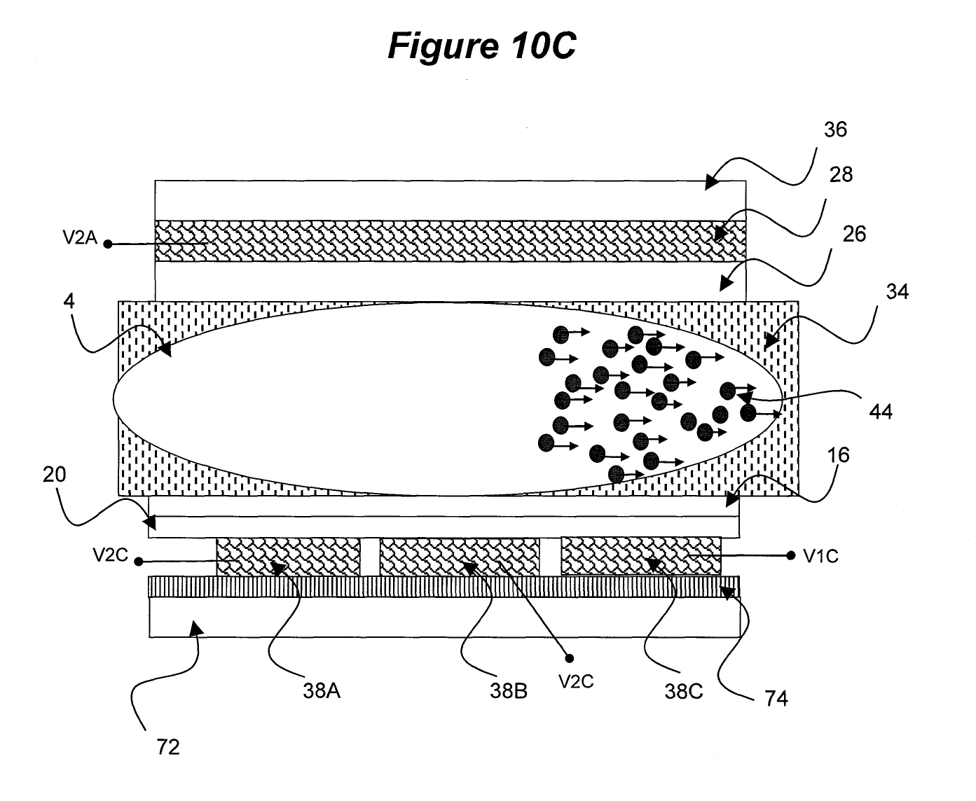

An example of how DEP and EWOD may be used to manipulate particles within the liquid droplet is shown in FIGS. 10A-10C. The figures show a cross section of a device, as in FIG. 4, and where three drive element electrodes 38A, 38B and 38C are shown. The liquid droplet 4 contains a number of particles 44. FIGS. 10A-100 show how the device may use DEP to perform the operation of concentrating particles within a liquid droplet, FIGS. 10A, 10B and 100 showing successive situations of the operation in time. By modifying the signals applied over time to electrodes 38A, 38B and 38C, the application of the electric field may be used to move dielectric particles 44 to one side of the liquid droplet 4 ((e.g., to the right as shown FIG. 100). At a still later time, the actuation mechanism may be switched to DC EWOD which may be used to split the droplet 4. The overall effect may therefore be used to concentrate the particles 44 within the liquid droplet 4. This could be used for example in a washing operation, whereby liquid surrounding particles 44 has excess reagent washed away. Another example application is in cell or bead concentration as may be used in a number of well known chemical or biochemical assays.

It may be noted that whilst the drive requirements for EWOD and DEP are similar and that switching between one and the other simply involves changing the frequency of the applied voltage waveform between electrode 38 and electrode 28, the two actuation mechanisms are physically completely different. Electro-wetting is essentially a surface phenomenon, and the strength of the electro-wetting force depends on the magnitude of the electric field at the interface between the liquid droplet 4 and the hydrophobic layer 16. DEP on the other hand is a bulk phenomenon, and the DEP force depends on the application of a time varying E-field through the bulk of the liquid droplet.

An advantage of this embodiment is that by facilitating both EWOD and DEP mechanisms within the same active matrix device, both liquid droplets 4 and dielectric particles 44 suspended within them can be independently controlled. This can have application in particle concentration, washing, particle sorting etc. which are useful or necessary steps in a number of applications of AM-EWOD technology, for example immunoassays for Point of Care diagnostics. The availability of both actuation measurements in an active matrix device facilitates the creation of large format fully reconfigurable devices that are capable of performing complex digital microfluidic operations and of performing a number of operations in parallel within the same device.

A further advantage is that the arrangement described is fully reconfigurable. In particular, any given column of the array can be arranged to perform either EWOD or DEP at a given point in time, and that different columns may be used to perform different functions simultaneously.

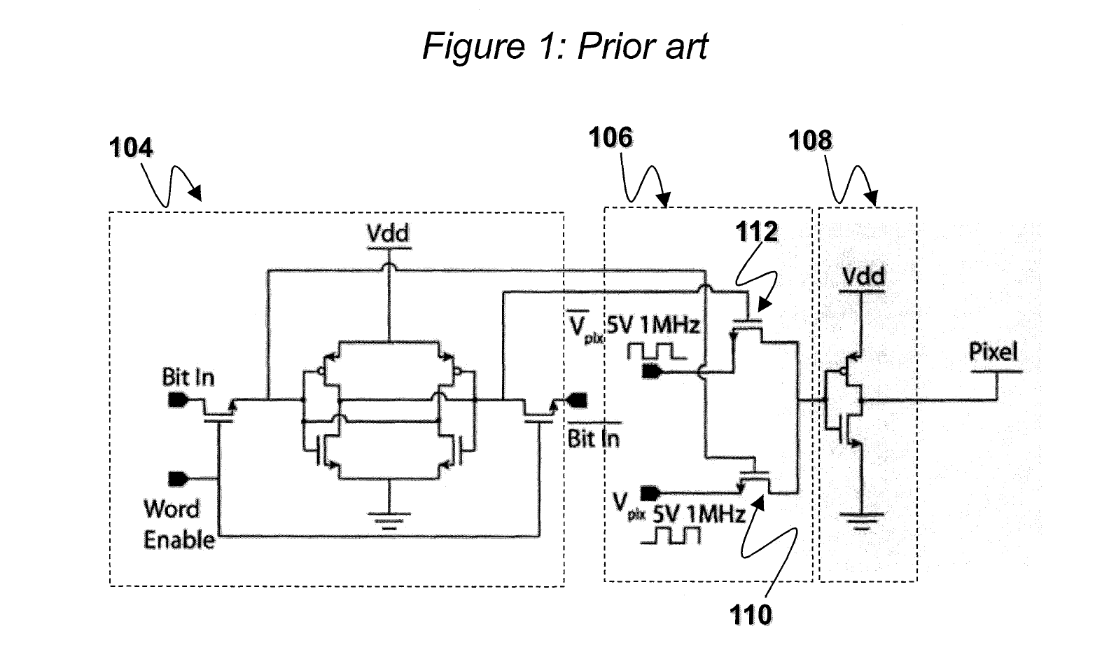

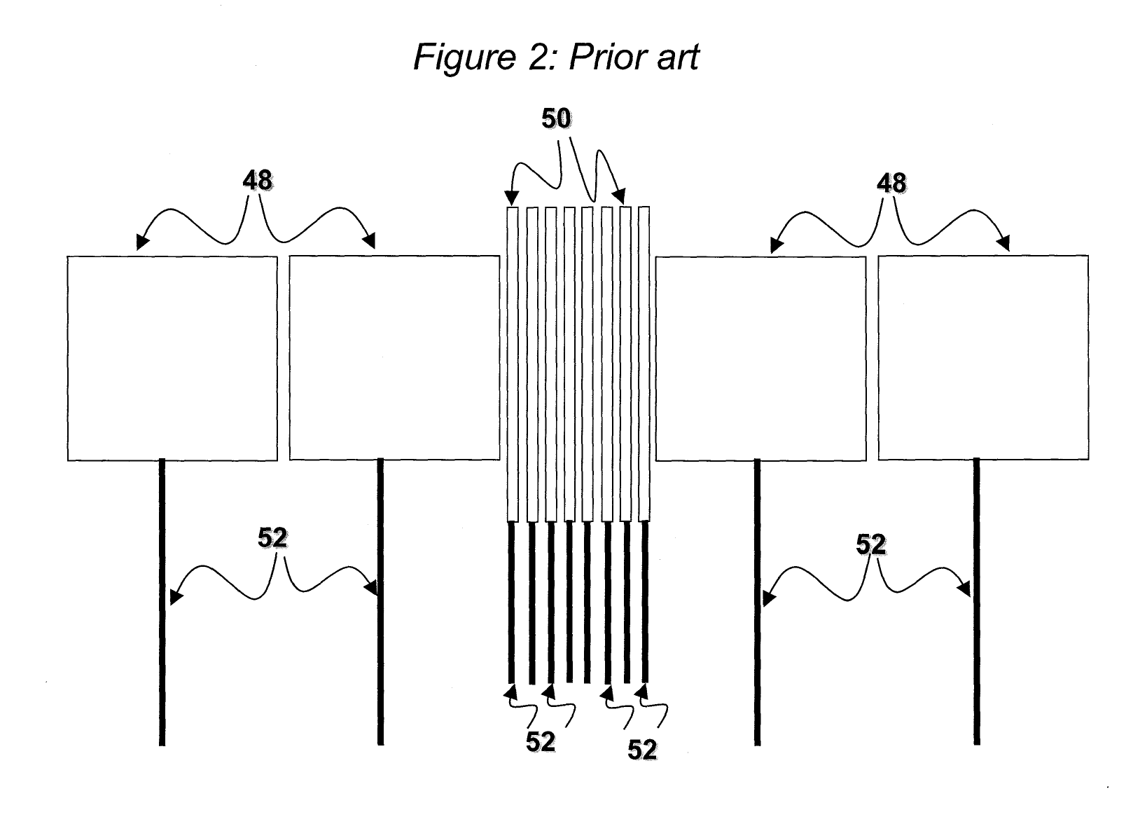

A further advantage of the circuit implementation described is that the number of electronic components within the array element circuit is relatively small. The same number of transistors are used in the array element circuit 84 of this embodiment as were used to perform just a DEP function as was shown in FIG. 1 and described in the background art section.

A further advantage of this embodiment is that the frequencies f₁ and f₂, associated with actuation by EWOD and DEP respectively, are entirely flexible and controllable independent of other timing parameters associated with the operation of the device. This is advantageous since the optimum operating frequency will be dependent on the properties of the medium of the liquid droplet 4 and of any dielectric particles 44 it contains.

A further advantage is that the high and low voltage levels of V1A, V1B and V1C (and their logic complements) may be adjusted to control the strength of the EWOD and DEP actuation mechanisms and it will be appreciated that the voltage levels required for implementing DEP and EWOD do not necessarily need to be the same. This advantage may be important, for example, to avoid excessive power consumption when performing DEP at high frequency.

Based on the disclosure herein, it will be obvious to one skilled in the art that a number of possible variants of the above embodiment could be implemented. For example, the signals V₁ and V₂ supplied to the array elements could be arranged to be common to elements within the same row instead of elements within the same column. Another possible variant would be for the second column driver 86 to select signals V₁ and V₂ based on just two possibilities, e.g. V1A and V1C as previously described and corresponding to the cases of options of actuating the liquid droplet 4 by either DC EWOD or by DEP.

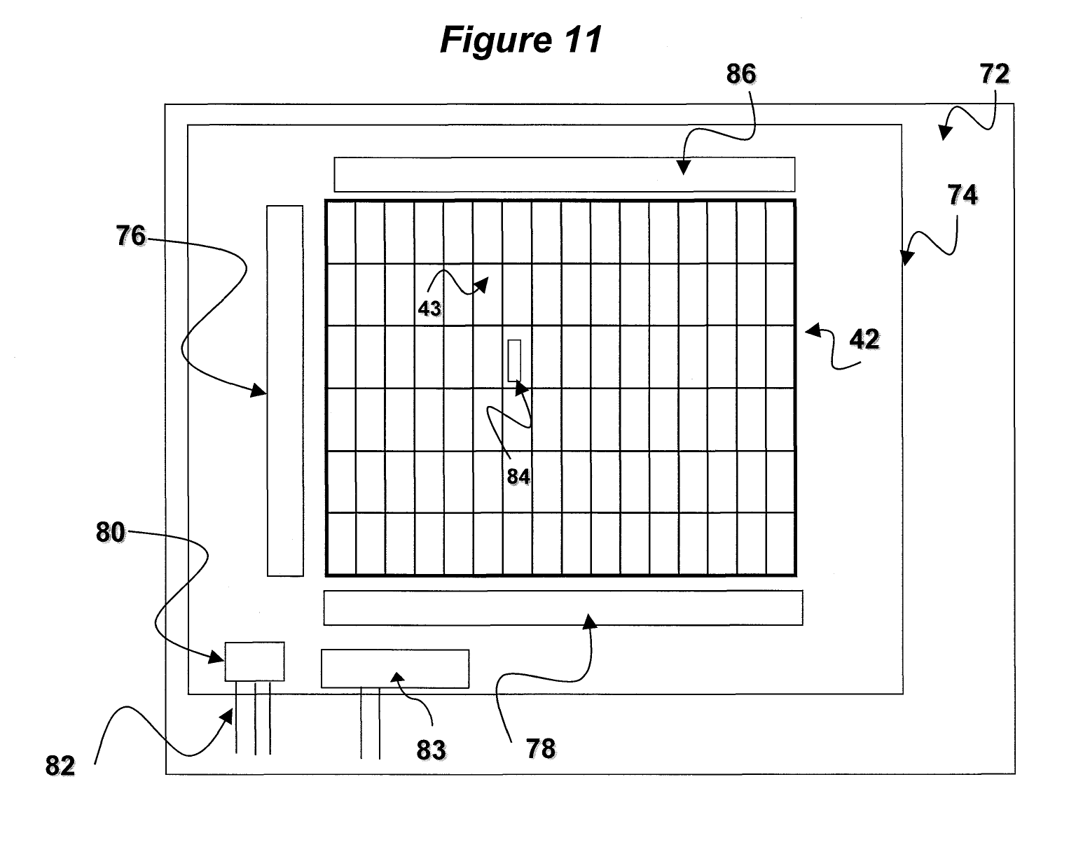

A second embodiment of the invention is as the first embodiment, where the array elements 43 are arranged so as to have a large aspect ratio, being significantly longer in the column direction than in the row direction. The arrangement of thin film electronics 74 according to this embodiment is shown in FIG. 11. According to this embodiment, the circuit schematics may be identical to the first embodiment, and the large aspect ratio may be realized by known layout techniques. By making the array element 43 smaller in the row direction, and by applying alternate DEP driving signals to array elements in adjacent columns (for example, V1C may be applied to the electrode 38 of the array elements in column Z and V2C may be applied to the electrodes 38 of the array elements in column Z+1), the gradient of the electric field and hence the strength of the DEP force is increased. According to the operation of this embodiment, DEP may preferentially be used to manipulate dielectric particles 44 within the liquid droplet 4 in the row direction, the maximum DEP force available being in the direction of the shorter length of array element 43. An advantage of this embodiment is that by maximizing the DEP force available, the efficacy of DEP operations, e.g. particle sorting is increased. A further advantage is that by maximizing the DEP actuation force in this way by means of the geometry, it may be possible to reduce the voltage amplitude of the signals V1C and V2C whilst still achieving sufficient DEP force. This will be advantageous for reducing power consumption etc.

It will be apparent to one skilled in the art that in a modification to this embodiment, the shorter dimension of the array element 43 could also be arranged to be in the column direction, with operation similar to as has already been described.

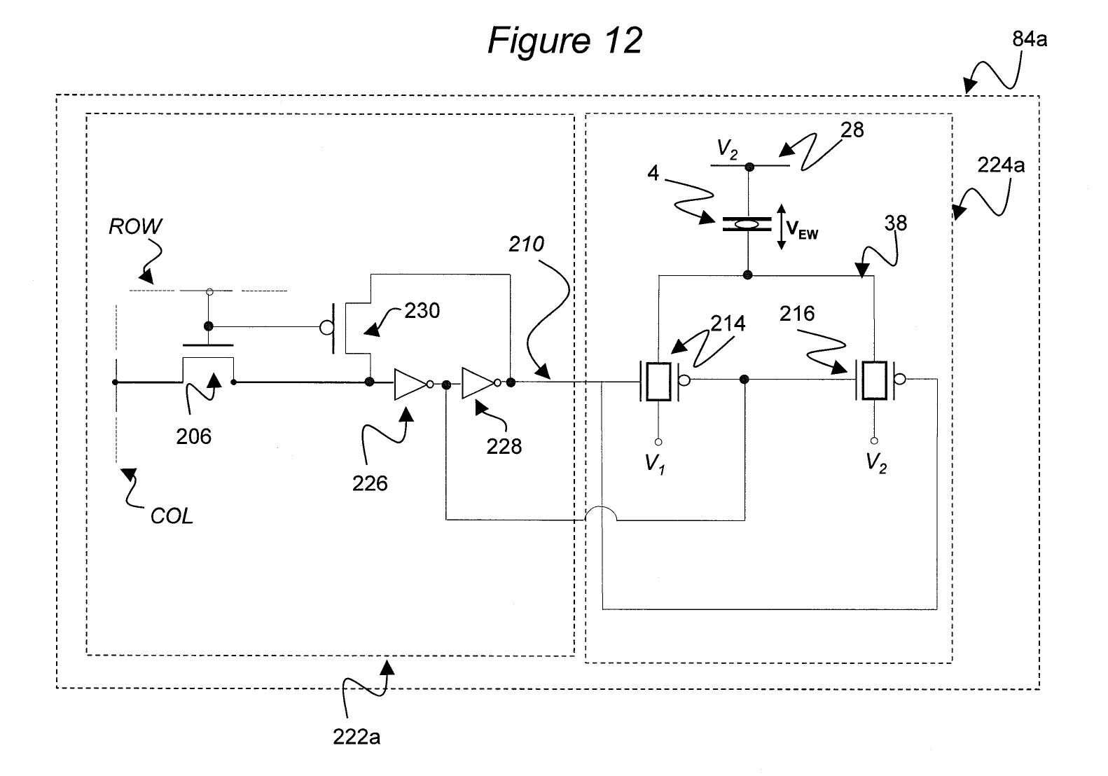

A third embodiment of the invention is as the first embodiment, whereby an alternative array element circuit 84a is used, as is shown in FIG. 12. The remainder of the AM-EWOD device is of the standard construction previously described and includes a top substrate 36 having an electrode 28. The array element circuit 84a according to this embodiment performs the same function as that for the first embodiment, namely to supply one of voltage lines V1 or V2 to the electrode 38, thus controlling the voltage signal supplied between this electrode and the top electrode 28, and so across the liquid droplet 4.

The array element circuit 84a in this embodiment contains the following elements:
A memory circuit 222a including:
A column write line COL (originating from the first column driver circuit 78), which may be common to array elements within the same column
A row select line ROW (originating from the row driver circuit 76), which may be common to array elements within the same row
An n-type switch transistor 206
A p-type switch transistor 230
A first inverter 226
A second inverter 228
An inversion circuit 224a including:
A first analogue switch 214
A second analogue switch 216
A voltage supply V₁, which may be common to all elements within the array
A second voltage V₂, which may be common to all elements within the array

The circuit 84a is connected as follows:

The column write line COL is connected to the source of the switch transistor 206. The row select line ROW is connected to the gate of the switch transistor 206 and the gate of the switch transistor 230. The drain of the switch transistor 230 is connected to the drain of the switch transistor 206 and to the input of the first inverter 226. The output of the first inverter 226 is connected to the input of the second inverter 228, the gate of the p-type transistor of the first analogue switch 214 and the gate of the n-type transistor of the second analogue switch 216. The output of the second inverter 228 is connected to the gate of the n-type transistor of the first analogue switch 214 and to the gate of the p-type transistor of the second analogue switch 216 and to the source of the switch transistor 230. The voltage supply V₁ is connected to the input of the first analogue switch 214. The voltage V₂ is connected to the input of the second analogue switch 216 and to the top substrate electrode 28. The outputs of the first analogue switch 214 and the second analogue switch 216 are each connected to the conductive electrode 38 forming the EW drive electrode.

The operation of this embodiment is similar to the first embodiment. The memory function is written by applying a high voltage pulse to the row select line ROW so as to turn the switch transistors 206 and 230 on. The voltage on the column write line COL is then written to the memory node 210. The operation of the inversion circuit 224a is as described for the first embodiment, with the exception that the inverted memory node signal can be obtained from connection to the node between the two inverters 226,228.

An advantage of this embodiment is that the SRAM memory structure of the memory circuit 222a does not require continual refresh. This may facilitate device operation with lower power consumption than is possible with a DRAM memory function. The array element circuit 84a is implemented with a minimal number of active components (ten transistors) thus minimizing layout footprint and maximizing manufacturing yield.

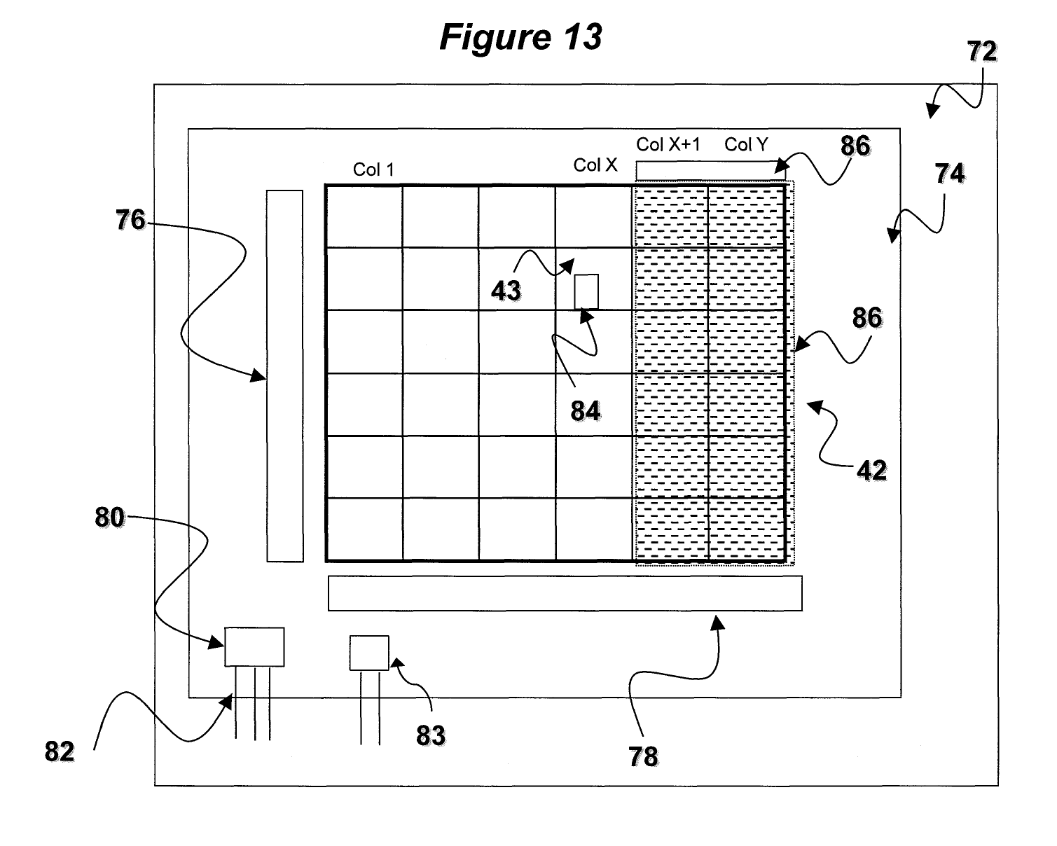

A fourth embodiment of the invention is as any of the previous embodiments where the dual EWOD/DEP function is restricted to just a part of the active matrix device. An example implementation of the thin film electronics in this embodiment is shown in FIG. 13. In this implementation, columns 1 to X, shown in the figure on the left hand side of the array, are designed to manipulate the liquid droplet solely using EWOD; the signals V₁ and V₂ supplied to these columns may be hardwired to supply lines, e.g. V1A and V1B, and are not required to be switchable between different driving options. Columns 1 to X would therefore be used just for the purpose of manipulating droplets by EWOD. Columns X+1 to Y of the array may be of an architecture as previously described, having a second column driver circuit 86, such that the signal lines V₁ and V₂ supplied to array elements within these columns can take options V1A, V1B or V1C, etc., as previously described for the first embodiment. Therefore in these columns of the array, liquid droplets 4 can be manipulated by EWOD or by DEP as previously described. This embodiment thus describes an AM-EWOD device having a dedicated “DEP zone” 46 (i.e. columns X+1 to Y) where DEP may also be performed. In operation of the device, in order to perform DEP, a droplet would be moved by means of electro-wetting to a location somewhere in the DEP zone 46. The required DEP operation, e.g. cell sorting, could be performed before then moving the droplet 4 to a different location in the array, for example as may be required for the next stage of the assay being performed.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

The AM-EWOD device could form a part of a lab-on-a-chip system. Such devices could be used in manipulating, reacting and sensing chemical, biochemical or physiological materials. Applications include healthcare diagnostic testing, chemical or biochemical material synthesis, proteomics, tools for research in life sciences and forensic science.

1. A microfluidic device, comprising:
a plurality of array elements configured to manipulate one or more droplets of fluid on an array, each of the array elements including a top substrate electrode and a drive electrode between which the one or more droplets may be positioned, the top substrate electrode being formed on a top substrate, and the drive electrode being formed on a lower substrate; and
active matrix drive circuitry arranged to provide drive signals to the top substrate and drive electrodes of the plurality of array elements to manipulate the one or more droplets among the plurality of array elements,
wherein with respect to one or more of the array elements the active matrix drive circuitry is configured to provide the drive signals to the top substrate and drive electrodes to selectively manipulate the one or more droplets within the array element both by Electro-wetting-on-Dielectric (EWOD) and by Dielectrophoresis (DEP).

2. The device according to claim 1, wherein the active matrix drive circuitry is operative to render the device reconfigurable in that the one or more droplets in a given part of the array can be manipulated by EWOD at one time and by DEP at another time.

3. The device according to claim 1, wherein the active matrix drive circuity is configured to selectively provide the drive signals the top substrate and drive electrodes of the one or more array elements in order to be either a DC or relatively low frequency AC voltage waveform across the one or more liquid droplets to manipulate the one or more liquid droplets by EWOD, or a relatively high frequency AC voltage waveform for manipulating the one or more droplets by DEP.

4. The device according to claim 1, wherein the one or more array elements are located in different parts of the array, and the active matrix drive circuitry is configured so as to be capable of manipulating at the same time some of the one or more droplets in one of the parts by EWOD and others of the one or more droplets in another of the parts by DEP.

5. The device according to claim 1, wherein the array elements are arranged in an M×N array, where M and N are both equal to or greater than 2.

6. The device according to claim 5, wherein the active matrix drive circuitry is configured in order that EWOD or DEP actuation may be selected individually for each column in the array at any particular time.

7. The device according to claim 5, wherein the active matrix circuitry includes a row driver circuit configured to select rows within the array, a first column driver circuit for providing write voltages to the array elements within a given row when selected, and a second column driver circuit for providing the drive signals to the top substrate electrodes and drive electrodes of respective columns within the array to selectively manipulate the one or more droplets within the respective columns by EWOD or DEP based on the write voltages provided to the array elements within the respective columns.

8. The device according to claim 5, wherein the active matrix circuitry is configured with respect to some columns in the array to manipulate the one or more droplets solely using EWOD, and with respect to other columns in the array to manipulate the one or more droplets selectively by EWOD or DEP.

9. The device according to claim 5, wherein the active matrix drive circuitry is configured in order that EWOD or DEP actuation is selected individually for each row in the array at any particular time.

10. The device according to claim 1, wherein the drive signals include at least one of DC signal and a relatively low frequency signal, a relatively high frequency signal, and logical complements thereof.

11. The device according to claim 10, wherein the DC signal and its logical complement are selectively applied to the top substrate electrode and the drive electrode of a given array element to manipulate the one or more droplets therein by DC EWOD.

12. The device according to claim 10, wherein the relatively low frequency signal and its logical complement are selectively applied to the top substrate electrode and the drive electrode of a given array element to manipulate the one or more droplets therein by AC EWOD.

13. The device according to claim 10, wherein the relatively high frequency signal and its logical complement are selectively applied to the top substrate electrode and the drive electrode of a given array element to manipulate the one or more droplets therein by DEP.

14. The device according to claim 1, wherein the array elements have a large aspect ratio.

15. The device according to claim 1, wherein the array elements share a common top substrate electrode.

16. A method of driving a microfluidic device which includes a plurality of array elements configured to manipulate one or more droplets of fluid on an array, comprising:
selectively supplying by way of active matrix drive circuitry a DC or relatively low frequency AC voltage, and a relatively high frequency AC voltage, across the one or more droplets within one or more of the array elements to manipulate the one or more droplets by Electro-wetting-on-Dielectric (EWOD) and Dielectrophoresis (DEP), respectively.

17. The method according to claim 16, comprising manipulating the one or more droplets in a given part of the array by EWOD at one time and by DEP at another time.

18. The method according to claim 16, comprising manipulating at the same time some of the one or more droplets in one part of the array by EWOD and others of the one or more droplets in another part by DEP.

19. The method according to claim 16, wherein the array elements are arranged in an M×N array, where M and N are both equal to or greater than 2, and the active matrix drive circuitry is configured in order that EWOD or DEP actuation may be selected individually for each column in the array at any particular time.

20. The method according to claim 19, wherein the active matrix circuitry includes a row driver circuit configured to select rows within the array, a first column driver circuit for providing write voltages to the array elements within a given row when selected, and a second column driver circuit for providing the drive signals to the respective columns within the array to selectively manipulate the one or more droplets within the respective columns by EWOD or DEP based on the write voltages provided to the array elements within the respective columns.
